(19) United States
(12) Patent Application Publication
(10) Pub. No.: US 2023/0407037 A1
(43) Pub. Date: Dec. 21, 2023

(54) A HIGH ENERGY RETURN FOAM AND METHOD FOR PREPARING THE SAME

(71) Applicant: Dow Global Technologies LLC, Midland, MI (US)

(72) Inventors: Bo Lyu, Zhejiang (CN); Xiaochun Liu, Jiangsu (CN); Jinliang Yan, Shanghai (CN)

(21) Appl. No.: 18/251,159

(22) PCT Filed: Mar. 30, 2021
(86) PCT No.: PCT/CN2021/083881

§ 371 Date: Apr. 28, 2023

(30) Foreign Application Priority Data
Dec. 14, 2020 (WO) PCT/CN2021/083881

(51) Int. Cl. C08J 9/228; C08J 9/12

(52) U.S. Cl. CPC C08J 9/228; C08J 9/122; C08J 2201/026; C08J 2323/08

(57) ABSTRACT

The present disclosure relates to a high energy return foam and method for preparing the same.

### FIELD OF THE INVENTION

The present disclosure relates to a high energy return foam and method for preparing the same.

### INTRODUCTION

Physical foaming is a hot topic in footwear applications. For this application, high rebound foam is highly preferred. In the market, there is a foaming technology which allows to form crosslinked blockers followed by putting them into an autoclave to obtain the foam. However, many of the foams can only achieve a rebound of 60-65%. Therefore, there still remains a constant demand for a high energy return foam exhibiting a high rebound of not less than 70%, preferably maintaining a low foam density, and/or good mechanical properties at the same time.

After persistent exploration, we have surprisingly found a high energy return foam which can achieve one or more of the above targets.

### SUMMARY OF THE INVENTION

In a first aspect of the present disclosure, the present disclosure provides a high energy return foam derived from a composition comprising from about 30 wt % to about 100 wt % of a polyolefin elastomer having a density of between about 0.857 g/cc and about 0.884 g/cc and a MI of not greater than about 5 g/10 min and from about 0 wt % to about 70 wt % of a polyolefin derivative having a density less than about 0.857 g/cc or greater than about 0.884 g/cc or having a MI of greater than about 5 g/10 min, based on the weight of the composition.

In a second aspect of the present disclosure, the present disclosure provides a method for preparing the high energy return foam of any one of the preceding claims, comprising:
a) providing a composition comprising from about 30 wt % to about 100 wt % of a polyolefin elastomer having a density of between about 0.857 g/cc and about 0.884 g/cc and a MI of not greater than about 5 g/10 min and from about 0 wt % to about 70 wt % of a polyolefin derivative having a density less than about 0.857 g/cc or greater than about 0.884 g/cc or having a MI of greater than about 5 g/10 min, based on the weight of the composition;
b) crosslinking the polymers in the composition obtained in step a);
c) foaming the resulting crosslinked polymers obtained in step b).

### BRIEF DESCRIPTION OF THE DRAWINGS

FIG. 1 shows the surface morphology of Examples in Table 1.

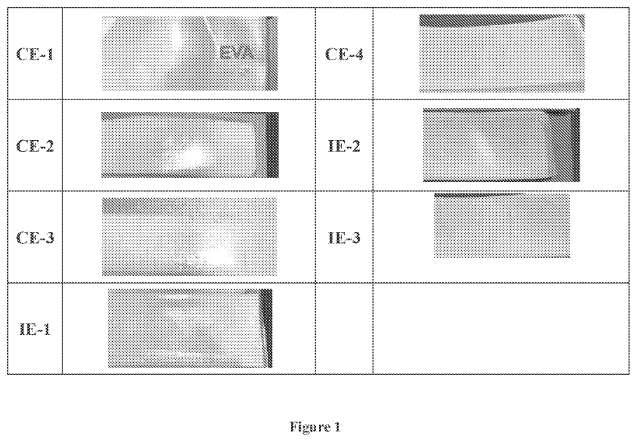

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

The numerical ranges disclosed herein include all values from, and including, the lower and upper value. For ranges containing explicit values (e.g., 1 or 2; or 3 to 5; or 6; or 7), any subrange between any two explicit values is included (e.g., 1 to 2; 2 to 6; 5 to 7; 3 to 7; 5 to 6; etc.). Unless stated to the contrary, implicit from the context, or customary in the art, all parts and percentages are based on weight and all test methods are current as of the filing date of this disclosure.

As disclosed herein, the term “composition”, “formulation” or “mixture” refers to a physical blend of different components, which is obtained by mixing simply different components by a physical means. The sum of the percentages by weight of each component in a composition is 100 wt %, based on the total weight of the composition.

As disclosed herein, “and/or” means “and, or as an alternative”. All ranges include endpoints unless otherwise indicated.

A “blowing agent” is a substance that is capable of producing a cellular structure in the composition via a foaming process.

The term “polymer” as used herein, refers to a polymeric compound prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers.

The term “interpolymer” as used herein, refers to polymer prepared by the polymerization of at least two different types of monomers. The term interpolymer thus includes the term copolymer (employed to refer to polymers prepared from two different types of monomers) and polymers prepared from more than two different types of monomers.

The term “polyolefin” or “olefin-based polymer,” as used herein, refers to a polymer that comprises, in polymerized form, 50 wt % or a majority weight percent of an olefin, such as ethylene or propylene (based on the weight of the polymer), and optionally may comprise one or more comonomers.

“High energy return foam” means a foam having a rebound of not less than 70%.

The high energy return foam is derived from a composition comprising from about 30 wt % to about 100 wt % of a polyolefin elastomer having a density of between about 0.857 g/cc and about 0.884 g/cc and a MI of not greater than about 5 g/10 min and from about 0 wt % to about 70 wt % of a polyolefin derivative having a density less than about 0.857 g/cc or greater than about 0.884 g/cc or a MI of greater than about 5 g/10 min, based on the weight of the composition.

The high energy return foam may derived from a composition comprising from about 30 wt % to about 100 wt %, or from about 35 wt % to about 100 wt %, or from about 40 wt % to about 100 wt %, or from about 45 wt % to about 100 wt %, or from about 50 wt % to about 100 wt %, preferably from about 70 wt % to about 100 wt %, more preferably from about 80 wt % to about 100 wt %, even more preferably from about 90 wt % to about 100 wt % of a polyolefin elastomer and from about 0 wt % to about 70%, or from about 0 wt % to about 65%, or from about 0 wt % to about 60%, or from about 0 wt % to about 55 wt %, or from about 0 wt % to about 50%, preferably from about 0 wt % to about 30 wt %, more preferably from about 0 wt % to about 20 wt %, even more preferably from about 0 wt % to about 10 wt % of a polyolefin derivative.

The polyolefin elastomer may have a density of between 0.857 g/cc and 0.884 g/cc, preferably between about 0.859 g/cc and 0.883 g/cc, more preferably between about 0.860 g/cc and about 0.882 g/cc, even more preferably between about 0.862 g/cc and about 0.880 g/cc, and a MI of not greater than about 5 g/10 min, preferably not greater than about 4 g/10 min, more preferably not greater than about 3 g/10 min, more preferably not greater than about 2 g/10 min, even more preferably not greater than about 1.5 g/10 min, even more preferably not greater than about 1.2 g/10 min, or less than 1 g/10 min.

The polyolefin elastomer having a density of between 0.857 g/cc and about 0.884 g/cc and a MI of not greater than about 5 g/10 min can be selected from ethylene/α-olefin random copolymer, ethylene/α-olefin multi-block interpolymer, ethylene/α-olefin/nonconjugated polyene interpolymer or a mixture of any two or more of them.

Preferably, the polyolefin elastomer has a density of between about 0.857 g/cc and about 0.884 g/cc, preferably between about 0.859 g/cc and 0.883 g/cc, more preferably between about 0.860 g/cc and about 0.882 g/cc, even more preferably between about 0.862 g/cc and about 0.880 g/cc.

Preferably, the polyolefin elastomer has a MI of not greater than about 5 g/10 min, preferably not greater than about 4 g/10 min, more preferably not greater than about 3 g/10 min, more preferably not greater than about 2 g/10 min, even more preferably not greater than about 1.5 g/10 min or not greater than 1.2 g/10 min, or not greater than 1 g/10 min. Alternatively, polyolefin elastomer has a MI from about 0.1 g/10 min to about 4 g/10 min, preferably about 0.2 g/10 min to about 3 g/10 min, more preferably about 0.3 g/10 min to about 1.5 g/10 min, even more preferably about 0.5 g/10 min to about 1.2 g/10 min.

Preferably, the polyolefin derivatives can be selected from ethylene vinyl acetate copolymer (EVA), low density polyethylene (LDPE) and linear low density polyethylene (LLDPE).

Preferably, the polyolefin derivative has a density of less than about 0.857 g/cc or greater than about 0.884 g/cc, or less than about 0.859 g/cc or greater than about 0.883 g/cc, preferably less than about 0.860 g/cc or greater than about 0.882 g/cc, more preferably less than about 0.862 g/cc or greater than about 0.880 g/cc.

Preferably, the polyolefin derivative has a MI of greater than 5 g/10 min, preferably greater than 6 g/10 min, more preferably greater than 7 g/10 min, even more preferably greater than 10 g/10 min.

Alternatively, the polyolefin derivative has a MI of greater than about 5 g/10 min, preferably greater than about 4 g/10 min, more preferably greater than about 3 g/10 min, more preferably greater than about 2 g/10 min, even more preferably greater than about 1.5 g/10 min or greater than 1.2 g/10 min, or greater than 1 g/10 min.

Preferably, the polymer in the composition is crosslinked and the crosslinked polymer has a gel % from about 50% to about 100% by weight by a hot xylene extraction method, preferably from about 52% to about 99.9% by weight by a hot xylene extraction method, more preferably from about 55% to about 99% by weight by a hot xylene extraction method, even more preferably from about 55% to about 75% by weight by a hot xylene extraction method.

The foam has a rebound of not less than about 70%, or not less than about 70.5%, preferably not less than about 71%, more preferably not less than about 72%, further preferably not less than about 73%, further preferably not less than about 73.5%, even more preferably not less than about 74%, or still more preferably not less than about 74.5%.

The foam has a density from about 0.05 g/cc to about 0.50 g/cc, preferably from about 0.08 to about 0.30 g/cc, more preferably from about 0.10 to about 0.25 g/cc, even more preferably from about 0.10 to about 0.14 g/cc.

The foam has a Asker C hardness from about 5 to about 70, more preferably from about 10 to about 60, even more preferably from about 12 to about 55, still more preferably from about 15 to about 35.

The foam has a tensile from about 0.5 to about 5 MPa, more preferably from about 0.8 to about 4.5 MPa, even more preferably from about 1 to about 4 MPa.

The foam has an elongation of not less than about 200%, or not less than about 250%, more preferably not less than 300%, even more preferably not less than about 400%, still more preferably not less than about 500%.

The foam has a 100% Modulus from about 0.1 to about 3 MPa, more preferably from about 0.2 to about 2 MPa, even more preferably from about 0.3 to about 1.8 MPa.

The foam has a Type C Tear from about 1 to about 20 kg/cm, more preferably from about 2 to about 15 kg/cm, even more preferably from about 4 to about 10 kg/cm.

The foam has a Split Tear from about 0.5 to about 10 kg/cm, more preferably from about 1 to about 4 kg/cm, even more preferably from about 1.2 to about 3.5 kg/cm.

The foam has a C-set (50° C., 6 h, 30 min) from about 20% to about 98%, more preferably from about 25% to about 80%, more preferably from about 30% to about 70%.

A) Ethylene/α-Olefin Random Copolymer

An ethylene/α-olefin copolymer is an ethylene/propylene random copolymer or an ethylene/C4-C8 α-olefin random copolymer. In an embodiment, the ethylene/α-olefin copolymer is an ethylene/C4-C8 α-olefin copolymer. The ethylene/C4-C8 α-olefin copolymer is composed of, or otherwise consists of, ethylene and one copolymerizable C4-C8 α-olefin comonomer in polymerized form. The C4-C8 α-olefin comonomer may be selected from 1-butene, 1-hexene, and 1-octene.

In an embodiment, the ethylene/α-olefin random copolymer for the inventive compositions described herein has a density of between about 0.857 g/cc and about 0.884 g/cc, preferably between about 0.859 g/cc and 0.883 g/cc, more preferably between about 0.860 g/cc and about 0.882 g/cc, even more preferably between about 0.862 g/cc and about 0.880 g/cc.

Preferably, the ethylene/α-olefin random copolymer for the inventive compositions described herein has a MI of not greater than about 5 g/10 min, preferably not greater than about 4 g/10 min, more preferably not greater than about 3 g/10 min, more preferably not greater than about 2, even more preferably not greater than about 1.5 g/10 min or not greater than 1.2 g/10 min, or not greater than 1 g/10 min. Alternatively, the ethylene/α-olefin random copolymer for the inventive compositions described herein has a MI from about 0.1 g/10 min to about 4 g/10 min, preferably about 0.2 g/10 min to about 3 g/10 min, more preferably about 0.3 g/10 min to about 1.5 g/10 min, even more preferably about 0.5 g/10 min to about 1.2 g/10 min.

Suitable ethylene/α-olefin random copolymer can be ENGAGE™ from Dow, such as ENGAGE™ 8150, or ENGAGE™ 7467.

B) Ethylene/α-Olefin Multi-Block Interpolymer

The term “ethylene/α-olefin multi-block interpolymer”, also called “olefin block copolymer (OBC)” as used herein, refers to an interpolymer that includes ethylene and one or more copolymerizable α-olefin comonomers in polymerized form, characterized by multiple blocks or segments of two or more (preferably three or more) polymerized monomer units, the blocks or segments differing in chemical or physical properties. Specifically, this term refers to a polymer comprising two or more (preferably three or more) chemically distinct regions or segments (referred to as “blocks”) joined in a linear manner, that is, a polymer comprising chemically differentiated units which are joined (covalently bonded) end-to-end with respect to polymerized functionality, rather than in pendent or grafted fashion. The blocks differ in the amount or type of comonomer incorporated therein, the density, the amount of crystallinity, the type of crystallinity (e.g., polyethylene versus polypropylene), the crystallite size attributable to a polymer of such composition, the type or degree of tacticity (isotactic or syndiotactic), region-regularity or region-irregularity, the amount of branching, including long chain branching or hyper-branching, the homogeneity, and/or any other chemical or physical property. The block copolymers are characterized by unique distributions of both polymer polydispersity (PDI or Mw/Mn) and block length distribution, e.g., based on the effect of the use of a shuttling agent(s) in combination with catalyst systems. Non-limiting examples of the olefin block copolymers of the present disclosure, as well as the processes for preparing the same, are disclosed in U.S. Pat. Nos. 7,858,706 B2, 8,198,374 B2, 8,318,864 B2, 8,609,779 B2, 8,710,143 B2, 8,785,551 B2, and 9,243,090 B2, which are all incorporated herein by reference in their entirety.

Ethylene/α-olefin multi-block interpolymers are characterized by multiple blocks or segments of two or more polymerized monomer units, differing in chemical or physical properties.

In some embodiments, the multi-block copolymers can be represented by the following formula: (AB)n, where n is at least 1, preferably an integer greater than 1, such as 2, 3, 4, 5, 10, 15, 20, 30, 40, 50, 60, 70, 80, 90, 100, or higher. Here, “A” represents a hard block or segment, and “B” represents a soft block or segment. Preferably the A segments and the B segments are linked in a substantially linear fashion, as opposed to a substantially branched or substantially star-shaped fashion. In other embodiments, the A segments and the B segments are randomly distributed along the polymer chain. In other words, for example, the block copolymers usually do not have a structure as follows: AAA-AA-BBB-BB. In still other embodiments, the block copolymers do not usually have a third type of block or segment, which comprises different comonomer(s). In yet other embodiments, each of block A and block B has monomers or comonomers substantially randomly distributed within the block. In other words, neither block A nor block B comprises two or more sub-segments (or sub-blocks) of distinct composition, such as a tip segment, which has a substantially different composition than the rest of the block.

The olefin block copolymers, in general, are produced via a chain shuttling process, such as, for example, described in U.S. Pat. No. 7,858,706, which is herein incorporated by reference. Some chain shuttling agents and related information are listed in Col. 16, line 39, through Col. 19, line 44. Some catalysts are described in Col. 19, line 45, through Col. 46, line 19, and some co-catalysts in Col. 46, line 20, through Col. 51 line 28. Some process features are described in Col 51, line 29, through Col. 54, line 56. See also the following: U.S. Pat. Nos. 7,608,668; 7,893,166; and 7,947,793 as well as US Patent Publication 2010/0197880. See also U.S. Pat. No. 9,243,173.

Preferably, ethylene comprises the majority mole fraction of the whole ethylene/α-olefin multi-block copolymer, i.e., ethylene comprises at least 50 wt % of the whole ethylene/α-olefin multi-block copolymer. More preferably, ethylene comprises at least 60 wt %, at least 70 wt %, or at least 80 wt %, with the substantial remainder of the whole ethylene/α-olefin multi-block interpolymer comprising the C4-C8 α-olefin comonomer, preferably, the C4-C8 α-olefin comonomer may be selected from 1-butene, 1-hexene, and 1-octene. In an embodiment, the ethylene/α-olefin multi-block interpolymer contains from 50 wt %, or 60 wt %, or 65 wt % to 80 wt %, or 85 wt %, or 90 wt % ethylene. For many ethylene/octene multi-block interpolymers, the composition comprises an ethylene content greater than 80 wt % of the whole ethylene/octene multi-block interpolymer and an octene content of from 10 wt % to 15 wt %, or from 15 wt % to 20 wt % of the whole ethylene/octene multi-block interpolymer.

The ethylene/α-olefin multi-block copolymer includes various amounts of “hard” segments and “soft” segments. “Hard” segments are blocks of polymerized units in which ethylene is present in an amount greater than 90 wt %, or 95 wt %, or greater than 95 wt %, or greater than 98 wt %, based on the weight of the polymer, up to 100 wt %. In other words, the comonomer content (content of monomers other than ethylene) in the hard segments is less than 10 wt %, or 5 wt %, or less than 5 wt %, or less than 2 wt %, based on the weight of the polymer, and can be as low as zero. In some embodiments, the hard segments include all, or substantially all, units derived from ethylene. “Soft” segments are blocks of polymerized units in which the comonomer content (content of monomers other than ethylene) is greater than 5 wt %, or greater than 8 wt %, or greater than 10 wt %, or greater than 15 wt %, based on the weight of the polymer. In an embodiment, the comonomer content in the soft segments is greater than 20 wt %, or greater than 25 wt %, or greater than 30 wt %, or greater than 35 wt %, or greater than 40 wt %, or greater than 45 wt %, or greater than 50 wt %, or greater than 60 wt % and can be up to 100 wt %.

The soft segments can be present in an ethylene/α-olefin multi-block interpolymer from 1 wt %, or 5 wt %, or 10 wt %, or 15 wt %, or 20 wt %, or 25 wt %, or 30 wt %, or 35 wt %, or 40 wt %, or 45 wt % to 55 wt %, or 60 wt %, or 65 wt %, or 70 wt %, or 75 wt %, or 80 wt %, or 85 wt %, or 90 wt %, or 95 wt %, or 99 wt % of the total weight of the ethylene/α-olefin multi-block interpolymer. Conversely, the hard segments can be present in similar ranges. The soft segment weight percentage and the hard segment weight percentage can be calculated based on data obtained from DSC or NMR. Such methods and calculations are disclosed in, for example, U.S. Pat. No. 7,608,668, the disclosure of which is incorporated by reference herein in its entirety. In particular, hard and soft segment weight percentages and comonomer content may be determined as described in column 57 to column 63 of U.S. Pat. No. 7,608,668.

In an embodiment, the ethylene/α-olefin multi-block copolymer is produced in a continuous process and possesses a polydispersity index (Mw/Mn) from 1.7 to 3.5, or from 1.8 to 3, or from 1.8 to 2.5, or from 1.8 to 2.2. When produced in a batch or semi-batch process, the ethylene/α-olefin multi-block copolymer possesses Mw/Mn from 1.0 to 3.5, or from 1.3 to 3, or from 1.4 to 2.5, or from 1.4 to 2.

Nonlimiting examples of suitable ethylene/α-olefin multi-block copolymer are disclosed in U.S. Pat. No. 7,608,668, the entire content of which is incorporated by reference herein.

In an embodiment, the ethylene/α-olefin multi-block copolymer has hard segments and soft segments, is styrene-free, consists of only (i) ethylene and (ii) a C4-C8 α-olefin, and is defined as having a Mw/Mn from 1.7 to 3.5.

In an embodiment, the ethylene/α-olefin multi-block interpolymer has a density of between about 0.857 g/cc and about 0.884 g/cc, preferably between about 0.859 g/cc and 0.883 g/cc, more preferably between about 0.860 g/cc and about 0.882 g/cc, even more preferably between about 0.862 g/cc and about 0.880 g/cc.

Preferably, the ethylene/α-olefin multi-block interpolymer for the inventive compositions described herein has a MI of not greater than about 5 g/10 min, preferably not greater than about 4 g/10 min, more preferably not greater than about 3 g/10 min, more preferably not greater than about 2 g/10 min, even more preferably not greater than about 1.5 g/10 min or not greater than 1.2 g/10 min, or not greater than 1 g/10 min. Alternatively, the ethylene/α-olefin multi-block interpolymer for the inventive compositions described herein has a MI from about 0.1 g/10 min to about 4 g/10 min, preferably about 0.2 g/10 min to about 3 g/10 min, more preferably about 0.3 g/10 min to about 1.5 g/10 min, even more preferably about 0.5 g/10 min to about 1.2 g/10 min.

Suitable ethylene/α-olefin multi-block interpolymer can be INFUSE™ from Dow, such as INFUSE™ 9107 OBC.

C) Ethylene/α-Olefin/Nonconjugated Polyene Interpolymer

The ethylene/α-olefin/nonconjugated polyene interpolymers for the inventive compositions described herein, comprise, in polymerize form, ethylene, an α-olefin, and a nonconjugated polyene.

Suitable examples of α-olefins include the C3-C20 α-olefins, further C3-C10 α-olefins, and preferably propylene.

The α-olefin may be either an aliphatic or an aromatic compound. The α-olefin is preferably a C3-C20 aliphatic compound, preferably a C3-C16 aliphatic compound, and more preferably a C3-C10 aliphatic compound. Preferred C3-C10 aliphatic α-olefins are selected from the group consisting of propylene, 1-butene, 1-hexene and 1-octene, and more preferably propylene. In a further embodiment, the interpolymer is an ethylene/propylene/nonconjugated diene (EPDM) terpolymer. In a further embodiment, the diene is 5-ethylidene-2-norbornene (ENB).

Suitable examples of nonconjugated polyenes include the C4-C40 nonconjugated dienes.

Illustrative nonconjugated polyenes include straight chain acyclic dienes, such as 1,4-hexadiene and 1,5-heptadiene; branched chain acyclic dienes, such as 5-methyl-1,4-hexadiene, 2-methyl-1,5-hexadiene, 6-methyl-1,5-heptadiene, 7-methyl-1,6-octadiene, 3,7-dimethyl-1,6-octadiene, 3,7-dimethyl-1,7-octadiene, 5,7-dimethyl-1,7-octadiene, 1,9-decadiene, and mixed isomers of dihydromyrcene; single ring alicyclic dienes such as 1,4-cyclohexadiene, 1,5-cyclooctadiene and 1,5-cyclododecadiene; multi-ring alicyclic fused and bridged ring dienes, such as tetrahydroindene, methyl tetrahydroindene; alkenyl, alkylidene, cycloalkenyl and cycloalkylidene norbornenes such as 5-methylene-2-norbornene (MNB), 5-ethylidene-2-norbornene (ENB), 5-vinyl-2-norbornene (VNB), 5-propenyl-2-norbornene, 5-isopropylidene-2-norbornene, 5-(4-cyclopentenyl)-2-norbornene, and 5-cyclohexylidene-2-norbornene. The polyene is preferably a nonconjugated diene selected from the group consisting of ENB, dicyclopentadiene, 1,4-hexadiene, 7-methyl-1,6-octadiene, and preferably, ENB, VNB, dicyclopentadiene and 1,4-hexadiene, 7-methyl-1,6-octadiene, and preferably, ENB, VNB, dicyclopentadiene and 1,4-hexadiene, more preferably ENB, VNB and dicyclopentadiene, and even more preferably ENB.

In one embodiment, the ethylene/α-olefin/nonconjugated polyene interpolymer comprises a majority amount of polymerized ethylene, based on the weight of the interpolymer. In a further embodiment, the ethylene/α-olefin/nonconjugated polyene interpolymer is an ethylene/α-olefin/diene interpolymer. In a further embodiment, the interpolymer is an EPDM. In a further embodiment, the diene is ENB.

In one embodiment, the ethylene/α-olefin/nonconjugated polyene interpolymer has a molecular weight distribution (Mw/Mn) from 2 to 50, further from 2 to 35, further from 2 to 25. In a further embodiment, the ethylene/α-olefin/nonconjugated polyene interpolymer is an ethylene/α-olefin/diene interpolymer (EAODM). In a further embodiment, the interpolymer is an EPDM. In a further embodiment, the diene is ENB.

In a further embodiment, the ethylene/α-olefin/nonconjugated polyene interpolymer is an ethylene/α-olefin/diene interpolymer. In a further embodiment, the interpolymer is an EPDM. In a further embodiment, the diene is ENB.

The EPDM as used in the present disclosure may for example comprise 50-85 wt % of polymeric units derived from ethylene. Preferably, the EPDM comprises 60-80 wt % of ethylene, more preferably 65-75 wt %.

The EPDM may comprise 15-50 wt % of polymeric units derived from propylene. Preferably, the EPDM comprises 20-45 wt % of polymeric units derived from propylene, more preferably 25-40 wt %.

The EPDM may comprise 0.1-15 wt % of polymeric units derived from a diene monomer. Preferably, the EPDM comprises 0.2-10 wt % of polymeric units derived from a diene monomer, more preferably 0.3-8 wt % of polymeric units derived from a diene monomer, still more preferably 0.5-6 wt % wt %.

The diene monomer may for example be one or more selected from 1,4-hexadiene, 1,6-octadiene, 5-methyl-1,4-hexadiene, 3,7-dimethyl-1,6-octadiene, dicyclopentadiene (DCPD), 5-vinyl-2-norbornene, 5-ethylidene-2-norbonene (ENB), and/or 2,5-norbornadiene. For example, the diene monomer may for example be one selected from 1,4-hexadiene, 1,6-octadiene, 5-methyl-1,4-hexadiene, 3,7-dimethyl-1,6-octadiene, dicyclopentadiene (DCPD), 5-vinyl-2-norbornene, 5-ethylidene-2-norbonene (ENB), or 2,5-norbornadiene. For example, the diene monomer may be selected from dicyclopentadiene (DCPD), 5-vinyl-2-norbornene, or 5-ethylidene-2-norbonene (ENB). It is particularly preferred that the diene monomer is 5-ethylidene-2-norbonene (ENB).

The EPDM may for example comprise 0.1-10 wt % of polymeric units derived from one or more selected from 1,4-hexadiene, 1,6-octadiene, 5-methyl-1,4-hexadiene, 3,7-dimethyl-1,6-octadiene, dicyclopentadiene (DCPD), 5-vinyl-2-norbornene, 5-ethylidene-2-norbonene (ENB), and/or 2,5-norbornadiene. The EPDM may for example comprise 0.1-10 wt % of polymeric units derived from 1,4-hexadiene, 1,6-octadiene, 5-methyl-1,4-hexadiene, 3,7-dimethyl-1,6-octadiene, dicyclopentadiene (DCPD), 5-vinyl-2-norbornene, 5-ethylidene-2-norbonene (ENB), or 2,5-norbornadiene. More preferably, the EPDM comprises 0.2-8 wt %, even more preferably 0.3-6 wt %, even more preferably 0.5-4 wt % of polymeric units derived from 1,4-hexadiene, 1,6-octadiene, 5-methyl-1,4-hexadiene, 3,7-dimethyl-1,6-octadiene, dicyclopentadiene (DCPD), 5-vinyl-2-norbornene, 5-ethylidene-2-norbonene (ENB), or 2,5-norbornadiene. Even more preferably, the EPDM comprises 0.1-10 wt % of polymeric units derived from DCPD, ENB or VNB, even more preferably 0.2-8 wt %, or 0.3-6 wt %. In a particular embodiment, the EPDM comprises 0.1-10 wt % of polymeric units derived from ENB, more preferably 0.2-8 wt %, or 0.3-6 wt % or 0.5-4 wt %.

In a particular embodiment, the EPDM comprises 0.1-10 w t %, 0.2-8 wt %, 0.3-6 wt % or 0.5-4 wt % of polymeric units derived from a diene monomer, wherein the diene monomer is selected from 1,4-hexadiene, 1,6-octadiene, 5-methyl-1,4-hexadiene, 3,7-dimethyl-1,6-octadiene, dicyclopentadiene (DCPD), 5-vinyl-2-norbornene, 5-ethylidene-2-norbonene (ENB), or 2,5-norbornadiene. More preferably, the EPDM comprises 0.1-15 wt %, preferably 0.2-10 wt %, more preferably 0.3-8 wt %, of polymeric units derived from a diene monomer, wherein the diene monomer is selected from dicyclopentadiene (DCPD), 5-vinyl-2-norbornene (VNB), or 5-ethylidene-2-norbonene (ENB). Even more preferably, the EPDM comprises 0.1-10 wt %, preferably 0.2-8 wt %, more preferably 0.3-6 wt %, of polymeric units derived from a diene monomer, wherein the diene monomer is 5-ethylidene-2-norbonene (ENB).

In a further particular embodiment, the EPDM comprises:
50-85 wt % of polymeric units derived from ethylene;
15-50 wt % of polymeric units derived from propylene; and
0.1-10 wt % of polymeric units derived from a diene monomer.

In another particular embodiment, the EPDM comprises:
50-85 wt % of polymeric units derived from ethylene;
15-50 wt % of polymeric units derived from propylene; and
0.1-10 wt % of polymeric units derived from a diene monomer, wherein the diene monomer is dicyclopentadiene (DCPD), 5-vinyl-2-norbornene (VNB), or 5-ethylidene-2-norbonene (ENB).

It is particularly preferred that the EPDM comprises:
60-80 wt % of polymeric units derived from ethylene;
20-45 wt % of polymeric units derived from propylene; and
0.2-8 wt % of polymeric units derived from a diene monomer, wherein the diene monomer is 5-ethylidene-2-norbonene (ENB).

Even more particularly is it preferred that the EPDM comprises:
65-75 wt % of polymeric units derived from ethylene;
25-40 wt % of polymeric units derived from propylene; and
0.3-6 wt % of polymeric units derived from a diene monomer, wherein the diene monomer is 5-ethylidene-2-norbonene (ENB).

In an embodiment, the ethylene/α-olefin/nonconjugated polyene interpolymer for the inventive compositions described herein has a density of between about 0.857 g/cc and about 0.884 g/cc, preferably between about 0.859 g/cc and 0.883 g/cc, more preferably between about 0.860 g/cc and about 0.882 g/cc, even more preferably between about 0.862 g/cc and about 0.880 g/cc.

Preferably, the ethylene/α-olefin/nonconjugated polyene interpolymer for the inventive compositions described herein has a MI of not greater than about 5 g/10 min, preferably not greater than about 4 g/10 min, more preferably not greater than about 3 g/10 min, more preferably not greater than about 2 g/10 min, even more preferably not greater than about 1.5 g/10 min or not greater than 1.2 g/10 min, or not greater than 1 g/10 min. Alternatively, the ethylene/α-olefin/nonconjugated polyene interpolymer for the inventive compositions described herein has a MI from about 0.1 g/10 min to about 4 g/10 min, preferably about 0.2 g/10 min to about 3 g/10 min, more preferably about 0.3 g/10 min to about 1.5 g/10 min, even more preferably about 0.5 g/10 min to about 1.2 g/10 min.

Suitable ethylene/α-olefin/nonconjugated polyene interpolymers for the inventive compositions described herein can be NORDEL™ from Dow, such as NORDEL™ IP3722, NORDEL™ IP3745 or the like.

Preparation Method

The composition of the present discourse is crosslinked and then foamed to form the foam of the present disclosure. The crosslinking can be performed by peroxide or by irradiation.

Crosslinking

“Crosslinking” refers to form chemical bonds between different polymer chains to form a network structure. The crosslinking can be performed by any of chemical reaction where above network can be formed. Below are some examples for crosslinking techniques including peroxide, irradiation, moisture curing with silane, hydrosilation, etc.

A crosslinking agent may be used for crosslinking the composition. The crosslinking agent is not particularly limited, as far as the crosslinking agent can crosslink the copolymer. The crosslinking agent used may be a known organic peroxide used for crosslinking a polyethylene-based resin. Examples thereof include the Percumyl series compound, such as dicumyl peroxide and tert-butylcumyl peroxide, the Perbutyl series compound, such as 1,1-bis(tert-butylperoxy)-3,3,5-trimethylcyclohexane, 2,5-dimethyl-2,5-di(tert-butylperoxy)hexane, and di-tert-butyl peroxide, the Perhexyl series compound, such as tert-hexyl peroxybenzoate, and the Perocta series compound, such as 1,1,3,3-tetramethylbutyl peroxy-2-ethylhexanoate. Among these, the Percumyl series compound and the Perbutyl series compound are preferred, and dicumyl peroxide is more preferred. These compounds may be used alone or as a combination of two or more kinds thereof. The lower limit of the amount of the crosslinking agent mixed is preferably 0.1 part by weight, and more preferably 0.2 part by weight, per 100 parts by weight of the total weight of the polymer. The upper limit of the amount of the crosslinking agent mixed is preferably 5.0 part by weight, and more preferably 2.5 part by weight, per 100 parts by weight of the total weight of the polymer.

In the case where the amount of the crosslinking agent added is in the range, the polymer is crosslinked to provide a crosslinked polymer having an appropriate gel fraction.

The crosslinking reaction is preferably performed at a temperature that is equal to or higher than the temperature, at which the polymer is softened and the crosslinking agent is substantially decomposed, which is specifically the 1-hour half-life period temperature of the organic peroxide or more and the melting point of the polyethylene-based resin or more. The temperature may be retained for 1 to 200 minutes to perform the crosslinking. For example, the crosslinking reaction is preferably performed at a temperature of 80-220° C., more preferably 120-210° C., even more preferably 150-200° C., or still more preferably 160-180° C.

The crosslinking reaction can also be performed by irradiation at a dose of, such as 30-150 KGy, preferably 40-120 KGy, more preferably 45-80 KGy.

The crosslinked polymer has a gel % from about 50% to about 100% by weight by a hot xylene extraction method, preferably from about 60% to about 100% by weight by a hot xylene extraction method, more preferably from about 65% to about 99.9% by weight by a hot xylene extraction method, even more preferably from about 70% to about 99% by weight by a hot xylene extraction method.

Foaming

A blowing agent is used for foaming the crosslinked polymers. The blowing agent used is not particularly limited, as far as the blowing agent can expand the crosslinked particles. Examples of the blowing agent include an inorganic physical blowing agent, such as air, nitrogen, carbon dioxide, argon, helium, oxygen, and neon, and an organic physical blowing agent, such as an aliphatic hydrocarbon, e.g., propane, n-butane, isobutane, n-pentane, isopentane, and n-hexane, an alicyclic hydrocarbon, e.g., cyclohexane and cyclopentane, a halogenated hydrocarbon, e.g., chlorofluoromethane, trifluoromethane, 1,1-difluoroethane, 1,1,1,2-tetrafluoroethane, methyl chloride, ethyl chloride, and methylene chloride, and a dialkyl ether, e.g., dimethyl ether, diethyl ether, and methyl ethyl ether. Among these, an inorganic physical blowing agent is preferred since it does not deplete the ozone layer and is inexpensive, nitrogen, air, and carbon dioxide are more preferred. The blowing agents may be used alone or as a combination of two or more kinds thereof. The crosslinking and foaming steps described above are preferably performed as a series of steps in different vessels.

The step of foaming by the blowing agent may be performed after the crosslinking step.

The temperature for foaming the crosslinked polymers is preferably not less than about 90° C., more preferably not less than about 95° C., more preferably not less than about 100° C., and further preferably not less than about 115° C. or not less than about 120° C. The upper limit of the temperature for the foaming with the blowing agent is preferably about 180° C., more preferably about 170° C., and further preferably about 165° C., even more preferably about 150° C.

The lower limit of pressure for foaming the crosslinked polymers is about 10 MPa, or about 15 MPa, preferably about 18 MPa, more preferably about 20 MPa, even more preferably about 22 MPa. In an embodiment, the pressure for foaming the crosslinked polymers is from about 10 to about 80 MPa, preferably from about 15 to about 70 MPa, more preferably from about 20 to about 50 MPa, even more preferably from about 20 to about 30 MPa.

### EXAMPLES

Some embodiments of the invention will now be described in the following Examples, wherein all parts and percentages are by weight unless otherwise specified.

The information of the raw materials used in the examples is listed in the following Table 1:

TABLE 1
Materials

| | | | Density | MI (2.16 kg, 190° |
|---|---|---|---|---|
| Materials | Provider | Type | (g/cc) | C.) (g/10 min) |
| ELVAX ™ 265 | Dow | EVA | 0.951 | 3 |
| | | (28VA %) | | |
| TAISOX ® | Taiso | EVA | 0.948 | 7.5 |
| 7470M | | (26VA %) | | |
| ENGAGE ™ | Dow | POE | 0.868 | 0.5 |
| 8150 | | | | |
| ENGAGE ™ | Dow | POE | 0.885 | 1 |
| 8003 | | | | |
| ENGAGE ™ | Dow | POE | 0.902 | 1 |
| 8480 | | | | |
| ENGAGE ™ | Dow | POE | 0.862 | 1.2 |
| 7467 | | | | |
| INFUSE ™ | Dow | OBC | 0.866 | 1 |
| 9107 OBC | | | | |
| INFUSE ™ | Dow | OBC | 0.887 | 5 |
| 9530 OBC | | | | |
| NORDEL ™ IP | Dow | EPDM | 0.88 | <1 (18MV*) |
| 3722 | | | | |
| NORDEL ™ IP | Dow | EPDM | 0.88 | <1 (45MV*) |
| 3745 | | | | |
| Luperox 101 | Arkema | Peroxide | 0.877 | — |

*MV: Mooney Viscosity at 125° C. (ASTM D 1646)

Sample Preparation

Polymer pellets were added into the 1 L internal mixer at 80-120° C. Then peroxide was then added in one shot. The resulting mixture was allowed to mix for further 5 min until the compound mixture reached 130-140° C. This residual was then transferred to two roll mill and cut into squares and placed inside a pre-heated bun foam mold. The preheating was conducted for 9 minutes at 120° C. and pressed at 10 tons for 4 minutes.

Crosslinking

1. For Peroxide Curing:

The preheated mass was transferred to the foaming press and held for 10 minutes at 100 kg/cm² and 180° C.

2. For Irradiation:

Irradiation was conducted in Lucky Star Irradiation Science Co. LTD (Lucky Star), in Shanghai, China. The irradiation was carried out by Co-60 and dosage was monitored by dosemeter (HKAgDc) and spectrophotometer (Shimadzu UV-2450) at Lucky Star.

Foaming

Resulted block was transferred into autoclave chamber. N₂ was then injected to reach desired inner pressure. This chamber was then heated to desire temperature for 4-8 h. Foam was afforded by removing the gas immediately after saturation.

Characterization

Foam Density

Bun foams were weighed to the nearest 0.1 g, and volume determined by measuring length, width, and thickness to the nearest 0.01 cm. The density could be calculated in terms of weight and volume.

Schob Type Rebound

The resilience of the foam (skin on), also called the rebound, was measured according to ASTM D7121 standard. The maximum rebound heights obtained for the 4th, 5th, and 6th bouncing of the impact head after the first strike were noted and their average was taken as the resilience of the specimen. Three specimens were tested for each foam sample and their average was reported as the resilience of the foam.

Compression Set

Compression Set (C-Set) was measured per ASTM D395 method B under conditions of 50% compression at 50° C. for 6 hours. Two buttons were tested per foam and the average reported. The compression set was calculated by using the following equation:

Compression set=(T₁−T₂)/(T₁−T₀)*100%

Where T₀ is the interval distance of the apparatus, T₁ is the sample thickness before test and T₂ is the sample thickness after test.

Asker C Hardness

The hardness was an average of five readings (5 seconds latency) measured across the surface of the sample.

MI

Melt index (MI) was measured at 190° C. under a load of 2.16 kg according to ASTM D1238. The result was recorded in grams eluted per 10 minutes (g/10 min).

Mechanical Properties

Bun foam skin layers were submitted for ASTM D638 (Tensile, Type 4) and ASTM D624 (Tear, Type C) mechanical property test at 20 inches/minute. The sample thickness was approximately 3 mm. The split tear strength was measured by using a specimen with the dimension of 6″ (length)*1″ (width)*0.4″ (thickness) and the notch depth of 1˜1.5″ at the testing speed of 2 inches/minute.

The Gel Fraction (Gel %)

The gel fraction by a hot xylene extraction method can be measured in the following manner. Approximately 0.1 g of the crosslinked polymer is weighed, and is designated as a specimen weight W₁. The weighed crosslinked polymer is placed in a 150 mL round-bottom flask, and 100 mL of xylene is placed in the round-bottom flask and refluxed under heating with a mantle heater for 6 hours. Thereafter, the residue remaining after dissolution in the round-bottom flask is separated by filtering with a 100-mesh metal mesh, and the separated product is dried in a vacuum dryer at 80° C. for 8 hours or more. The weight W₂ of the resulting dried product is measured. The weight percentage of the weight W₂ to the specimen weight W₁ ((W₂/W₁)×100) (%) is calculated and designated as the gel fraction.

### Examples and Discussion

The following Table 2 and 3 showed the comparative and inventive examples of current invention.

TABLE 2
Peroxide curing examples

| Sample | CE- | CE- | CE- | CE- | CE- | CE- | CE- | IE- | IE- | IE- | IE- |
|---|---|---|---|---|---|---|---|---|---|---|---|
| Name | 1 | 2 | 3 | 4 | 5 | 6 | 7 | 1 | 2 | 3 | 4 |
| TAISOX | 100 | 100 | | | 80 | 70 | 50 | | | | 50 |
| 7470M | | | | | | | | | | | |
| ENGAGE | | | 100 | | | | | 100 | | | |
| 8150 | | | | | | | | | | | |
| INFUSE | | | | | 20 | | | | 100 | 100 | 50 |
| 9107 | | | | | | | | | | | |
| INFUSE | | | | 100 | | | | | | | |
| 9530 | | | | | | | | | | | |
| ENGAGE | | | | | | 30 | 50 | | | | |
| 8003 | | | | | | | | | | | |
| Luperox | 0.4 | 0.4 | 0.4 | 0.9 | 0.4 | 0.4 | 0.4 | 0.4 | 0.65 | 0.58 | 0.4 |
| 101 | | | | | | | | | | | |
| Total | 100.4 | 100.4 | 100.4 | 100.9 | 100.4 | 100.4 | 100.4 | 100.4 | 100.65 | 100.58 | 100.4 |
| Resin | 0.948 | 0.948 | 0.868 | 0.887 | 0.948/ | 0.948/ | 0.948/ | 0.868 | 0.866 | 0.866 | 0.948/ |
| density | | | | | 0.866 | 0.885 | 0.885 | | | | 0.866 |
| (g/cc) | | | | | | | | | | | |
| Resin MI | 7.5 | 7.5 | 0.5 | 5 | 7.5/1 | 7.5/1 | 7.5/1 | 0.5 | 1 | 1 | 7.5/1 |
| (g/10 min) | | | | | | | | | | | |
| Gel % | 96.84 | 96.84 | 97.38 | 90.80 | 91.3 | 92.6 | 78.1 | 97.38 | 98.06 | 96.04 | 75.1 |
| Temperature | 80 | 100 | 80 | 125 | 140 | 140 | 140 | 100 | 125 | 125 | 140 |
| (° C.) | | | | | | | | | | | |
| Pressure | 22 | 22 | 22 | 26.4 | 20 | 20 | 20 | 22 | 22 | 26.4 | 20 |
| (MPa) | | | | | | | | | | | |
| Surface | R | S | R | S | S | S | S | S | S | S | S |
| quality* | | | | | | | | | | | |
| Rebound | NA | 56 | NA | 67 | 61 | 60 | 62 | 72 | 79 | 79 | 72 |
| (%)\hat{ } | | | | | | | | | | | |
| Density | NT | 0.203 | NT | 0.170 | 0.239 | 0.143 | 0.126 | 0.176 | 0.178 | 0.117 | 0.112 |
| (g/cc)^{#} | | | | | | | | | | | |
| Hardness | NT | 44.8 | NT | 53.6 | 41.6 | 38.4 | 33.6 | 31.8 | 34.8 | 25.0 | 23.4 |
| (Asker C) ^{#} | | | | | | | | | | | |
| Tensile | NT | 2.98 | NT | 3.31 | 2.57 | 1.91 | 1.87 | 3.75 | 3.91 | 1.73 | 1.40 |
| (MPa) ^{#} | | | | | | | | | | | |
| Elongation | NT | 206 | NT | 306 | 243 | 158 | 175 | 376 | 545 | 365 | 201 |
| (%)^{#} | | | | | | | | | | | |
| 100% | NT | 2.02 | NT | 1.77 | 1.70 | 1.38 | 1.22 | 1.1 | 0.83 | 0.49 | 0.77 |
| Modulus | | | | | | | | | | | |
| (MPa) ^{#} | | | | | | | | | | | |
| Split Tear | NT | 3.08 | NT | 3.83 | 1.92 | 1.21 | 1.25 | 2.24 | 3.12 | 1.41 | 0.79 |
| (kg/cm) ^{#} | | | | | | | | | | | |
| C-set (50° | NT | 62.8% | NT | 27.2% | 55.6% | 64.9% | 70.0% | 71.8% | 39.2% | 56.3% | 76.9% |
| C., 6 h, 30 | | | | | | | | | | | |
| min) ^{#} | | | | | | | | | | | |

*Rough (R); Smooth (S);
\hat{ }NA: Not able to determine due to poor surface roughness of foam.
^{#} NT: Not tested.

TABLE 3
Irradiation curing examples

| Sample | CE- | CE- | CE- | CE- | CE- | CE- | CE- | CE- | CE- | IE- | IE- | IE- | IE- | IE- |
|---|---|---|---|---|---|---|---|---|---|---|---|---|---|---|
| Name | 8 | 9 | 10 | 11 | 12 | 13 | 14 | 15 | 16 | 5 | 6 | 7 | 8 | 9 |
| TAISOX | 100 | 100 | | | | | | | | | | | | |
| 7470M | | | | | | | | | | | | | | |
| Elvax 265 | | | 100 | | | | | | | | | | | |
| ENGAGE | | | | 100 | 100 | | | | | | | | | |
| 8003 | | | | | | | | | | | | | | |
| ENGAGE | | | | | | 100 | | | | 100 | | | | |
| 8150 | | | | | | | | | | | | | | |
| ENGAGE | | | | | | | | | | | 100 | | | |
| 7467 | | | | | | | | | | | | | | |
| ENGAGE | | | | | | | 100 | | | | | | | |
| 8480 | | | | | | | | | | | | | | |
| INFUSE | | | | | | | | 100 | 100 | | | | | |
| 9107 | | | | | | | | | | | | | | |
| NORDEL | | | | | | | | | | | | 100 | 100 | |
| 3722 | | | | | | | | | | | | | | |
| NORDEL | | | | | | | | | | | | | | 100 |
| 3745 | | | | | | | | | | | | | | |
| Irradiation | 45 | 60 | 60 | 45 | 60 | 30 | 45 | 30 | 60 | 45 | 45 | 45 | 60 | 45 |
| dose | | | | | | | | | | | | | | |
| (KGy) | | | | | | | | | | | | | | |
| Resin | 0.948 | 0.948 | 0.951 | 0.885 | 0.885 | 0.868 | 0.902 | 0.866 | 0.866 | 0.868 | 0.862 | 0.88 | 0.88 | 0.88 |
| density | | | | | | | | | | | | | | |
| Resin MI | 7.5 | 7.5 | 3 | 1 | 1 | 0.5 | 1 | 1 | 1 | 0.5 | 1.2 | <1 | <1 | <1 |
| (g/10 min) | | | | | | | | | | | | | | |
| Gel % | 71.8 | 76.8 | 82.4 | 63.8 | 70.1 | 3.8 | 53.2 | 3.7 | 33.9 | 74.5 | 62.6 | 66.1 | 67.3 | >99.9 |
| Temperature | 100 | 100 | 100 | 120 | 120 | 100 | 120 | 125 | 150 | 100 | 120 | 120 | 120 | 120 |
| (° C.) | | | | | | | | | | | | | | |
| Pressure | 20 | 20 | 20 | 20 | 20 | 25 | 20 | 26 | 20 | 25 | 20 | 20 | 20 | 20 |
| (MPa) | | | | | | | | | | | | | | |
| Rebound | 57 | 54 | 52 | 59 | 55 | NA | 46 | NA | 67 | 80 | 72 | 72 | 74 | 77 |
| (%)\hat{ } | | | | | | | | | | | | | | |
| Density | 0.136 | 0.231 | 0.270 | 0.087 | 0.098 | NT | 0.120 | NT | 0.140 | 0.089 | 0.142 | 0.124 | 0.173 | 0.230 |
| (g/cc)^{#} | | | | | | | | | | | | | | |
| Hardness | 30.8 | 44.2 | 43.4 | 24.8 | 23.6 | NT | 46.6 | NT | 18.4 | 16.6 | 17 | 24.2 | 34.8 | 32.8 |
| (Asker C) ^{#} | | | | | | | | | | | | | | |
| Tensile | 1.53 | 1.69 | 2.2 | 2.4 | 2.59 | NT | 2.12 | NT | 2.2 | 1.51 | 0.95 | 1.08 | 1.56 | 2.41 |
| (MPa) ^{#} | | | | | | | | | | | | | | |
| Elongation | 140.5 | 126.7 | 114.4 | 319.1 | 287.3 | NT | 189.7 | NT | 616.6 | 318 | 721.7 | 257 | 282.7 | 350.1 |
| (%)^{#} | | | | | | | | | | | | | | |
| 100% | 1.22 | 1.66 | 2.22 | 0.84 | 1.01 | NT | 1.5 | NT | 0.41 | 0.45 | 0.28 | 0.56 | 0.83 | 0.95 |
| Modulus | | | | | | | | | | | | | | |
| (MPa) ^{#} | | | | | | | | | | | | | | |
| Type C | 6.22 | 7.63 | 14.33 | 7.35 | 7.75 | NT | 9.94 | NT | 7.25 | NT | 6.53 | 4.36 | 6.54 | 9.42 |
| Tear | | | | | | | | | | | | | | |
| (kg/cm) ^{#} | | | | | | | | | | | | | | |
| C-set (50° | 30.8 | 44.2 | 53.1 | 82.2 | 77.8 | NT | 62.9 | NT | 45.8 | 88.3 | 46.5 | 63.6 | 48.2 | 42.0 |
| C., 6 h, 30 | | | | | | | | | | | | | | |
| min) ^{#} (%) | | | | | | | | | | | | | | |

\hat{ }NA: Not able to determine due to poor surface roughness of foam.
^{#}NT: Not tested

From the results of the inventive examples and comparative examples, it can be seen that polyolefin elastomer having a density of between about 0.857 g/cc and about 0.884 g/cc and a MI of not greater than about 5 g/10 min can be used to produce a foam having a rebound of not less than 70%.

1. A high energy return foam derived from a composition comprising from about 30 wt % to about 100 wt % of a polyolefin elastomer having a density of between about 0.857 g/cc and about 0.884 g/cc and a MI of not greater than about 5 g/10 min and from about 0 wt % to about 70 wt % of a polyolefin derivative having a density less than about 0.857 g/cc or greater than about 0.884 g/cc or having a MI of greater than about 5 g/10 min, based on the weight of the composition.

2. The high energy return foam of claim 1, wherein the polyolefin elastomer is selected from ethylene/α-olefin random copolymer, ethylene/α-olefin multi-block interpolymer, ethylene/α-olefin/nonconjugated polyene interpolymer or a mixture of any two or more of them.

3. The high energy return foam of claim 1, wherein the foam has a rebound of not less than 70%.

4. The high energy return foam of claim 1, wherein the polymer in the composition is crosslinked and the crosslinked polymer has a gel % of from about 50% to about 100% by weight by a hot xylene extraction method.

5. The high energy return foam of claim 1, wherein the crosslinking is performed by peroxide or by irradiation.

6. The high energy return foam of claim 4, wherein the crosslinked polymer is foamed at temperature of not less than about 90° C. and at a pressure from about 10 to about 80 MPa.

7. The high energy return foam of claim 4, wherein the crosslinked polymer is foamed at temperature from about 100° C. to about 150° C. and at a pressure from about 15 to about 70 MPa.

8. The high energy return foam of claim 4, wherein the foam has a rebound of not less than 72%.

9. The high energy return foam of claim 1, wherein the composition comprises from about 35 wt % to about 100 wt % of a polyolefin elastomer having a density of between about 0.857 g/cc and about 0.884 g/cc and a MI of not greater than about 5 g/10 min and from about 0 wt % to about 65 wt % of a polyolefin derivative having a density less than about 0.857 g/cc or greater than about 0.884 g/cc or having a MI of greater than about 5 g/10 min, based on the weight of the composition.

10. The high energy return foam of claim 1, wherein the composition comprises from about 50 wt % to about 100 wt % of a polyolefin elastomer having a density of between about 0.857 g/cc and about 0.884 g/cc and a MI of not greater than about 5 g/10 min and from about 0 wt % to about 50 wt % of a polyolefin derivative having a density less than about 0.857 g/cc or greater than about 0.884 g/cc or having a MI of greater than about 5 g/10 min, based on the weight of the composition.

11. A method for preparing the high energy return foam of claim 1, comprising:
a) providing a composition comprising from about 30 wt % to about 100 wt % of a polyolefin elastomer having a density of between about 0.857 g/cc and about 0.884 g/cc and a MI of not greater than about 5 g/10 min and from about 0 wt % to about 70 wt % of a polyolefin derivative having a density less than about 0.857 g/cc or greater than about 0.884 g/cc or having a MI of greater than about 5 g/10 min, based on the weight of the composition;
b) crosslinking the polymers in the composition obtained in step a);
c) foaming the resulting crosslinked polymers obtained in step b).

12. The method of claim 11, wherein the crosslinking is performed by peroxide or by irradiation.

13. The method of claim 11, wherein the crosslinked polymer is foamed at temperature of not less than about 90° C. and at a pressure from about 10 to about 80 MPa.

14. The method of claim 11, wherein the crosslinked polymer is foamed at temperature from about 100° C. to about 150° C. and at a pressure from about 15 to about 70 MPa.

15. The method of claim 11, wherein the foam has a rebound of not less than 70%.
